(19) United States
(12) Patent Application Publication
(10) Pub. No.: US 2004/0009362 A1
(43) Pub. Date: Jan. 15, 2004

(54) Shaped body with a mineral clay coating

(76) Inventors: Mario Sandor, Obrigheim (DE); Manfred Schwartz, Frankenthal (DE); Bertold Bechert, Grunstadt (DE); Harm Wiese, Heidelberg (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/362,681

(22) PCT Filed: Sep. 3, 2001
(86) PCT No.: PCT/EP01/10132

(30) Foreign Application Priority Data
Sep. 4, 2000 (DE) 100 43 452.5

(51) Int. Cl. B05D 3/02

(52) U.S. Cl. 428/500; 427/385.5; 428/688

(57) ABSTRACT

Moldings comprise a base element consisting of a cement-bound mineral material, which may be modified with polymers, and a mineral coating present on at least one of the main surfaces of the base element and comprising a polymer-modified mineral material which contains at least one clay mineral as the main component and at least one film-forming, hydrophobic polymer distributed in the mineral material.

The present invention relates to a molding, a base element consisting of a cement-bound mineral material, which may be modified with polymers and comprises a mineral coating present on at least one of the main surfaces of the base element, and a process for its production.

Moldings consisting of a cement-bound mineral material, i.e. concrete moldings and structural elements comprising concrete, are used as building materials in many areas of the building industry, for example as concrete pipes for rainwater and wastewater, curb stones, floor slabs, base slabs, steps, wall components and concrete roof tiles.

Concrete roof tiles are roof tile-shaped concrete moldings which have recently been increasingly used in place of the conventional clay roof tiles for covering roofs.

Concrete moldings, in particular concrete roof tiles, are produced from plastic concrete materials which have not set by shaping, as a rule by extrusion methods. For coloring, these concrete materials generally contain an inorganic colored pigment, for example iron oxide red pigments or iron oxide black pigments.

Concrete moldings are superior to comparable clay moldings, owing to their higher mechanical strength. A further advantage of concrete moldings over conventional clay moldings is the far more advantageous production price. However, owing to a rougher surface, the appearance of concrete moldings is frequently unsatisfactory. Moreover, with weathering, some of the calcium contained in them travels to the surface and leads to unattractive efflorescence there. The rough surface of the concrete moldings promotes erosion and facilitates in particular the undesired infestation with plant organisms, such as algae, lichens and mosses.

Where it has been possible recently substantially to solve the problem of weathering-related efflorescence by treating the surface with coating materials based on aqueous polymer dispersions, there are no economical solutions for the production of concrete moldings, in particular concrete roof tiles, having smooth surfaces.

GB-A 2,030,890 proposes providing concrete roof tiles produced by the extrusion method with a cement-bound mineral coating which essentially contains cement, water and pigments. The coating is applied by extrusion or roll-coating, as a rule to the concrete roof tile blank (i.e. green concrete roof tile) produced freshly by an extrusion process and not yet set. The coatings lead to a smoother surface of the concrete roof tile. However, the coatings have the disadvantage that they easily flake off. In addition, they are uneconomical owing to the high cement content.

DE-A 3932573 describes concrete roof tiles which are provided with a mineral coating which, in addition to cement as a binder, very fine sand as an additive and inorganic pigments, contains a cement-compatible polymer.

The cement-containing coatings of the prior art have the disadvantage that they easily flake off. The processing of the cement-containing coating materials is often problematic. Moreover, they are uneconomical owing to the high cement content. Their appearance is not always satisfactory, in particular compared with conventional clay tiles.

It is an object of the present invention to provide moldings which are based on mineral components and which have the mechanical strength of concrete moldings and at the same time have the attractive appearance and the weathering resistance of moldings comprising clay ceramic materials. This object is only inadequately achieved by the prior art.

Experiments by the applicant itself have shown that coatings comprising clay likewise solve these problems only inadequately. Although coatings having a smooth surface are obtained in this manner, the coating has only limited weathering resistance. For example, on the one hand, it cannot effectively prevent efflorescence. On the other hand, these coatings cannot be provided with conventional efflorescence protection based on a polymer-bound coating, since this does not adhere to coatings comprising clay.

We have found, surprisingly, that this object can be achieved if the concrete base element is provided with a clay-based coating which is modified with polymers, i.e. which contains at least one finely divided polymer in addition to the clay mineral components.

The present invention therefore relates to moldings comprising a base element consisting of a cement-bound mineral material, which may be modified with polymers, and a mineral coating present on at least one of the main surfaces of the base element and comprising a polymer-modified mineral material which contains at least one clay mineral as the main component and at least one film-forming polymer distributed in the mineral material.

Such moldings are of interest in particular as roof construction tiles. Roof construction tiles are understood here as meaning also gable tiles, ridge tiles, stepped tiles, air bricks and other clay roof elements used for covering roofs, in addition to the conventional pantiles.

The mineral material which forms the coating essentially comprises mineral components which contain, as the main component, i.e. in amounts of >50, in particular >80, % by weight, based on the mineral components of the material, at least one clay mineral, such as kaolinite, illite, halloysite and montmorillonite, and, if required, other silicates, silicas, aluminosilicates, such as feldspars, calcium carbonate, quartz sand, etc., as secondary components. Such materials are commercially available as clays. A preferred embodiment of the invention relates to a molding based on illitic clay.

The polymers used according to the invention for modifying the clay mineral-containing coating are film-forming. This is understood as meaning that the polymer particles of the film-forming polymer coalesce to form a polymer film at a temperature which is above the temperature of production of the moldings. The temperature above which a film formation occurs is also referred to as the mineral film formation temperature (MFT).

Uniform film formation of the hydrophobic polymer used in the production of the molding is as a rule ensured when the glass transition temperature T_{g} of the polymer is below 80° C., preferably below 50° C. The glass transition temperature is understood here as meaning the mid-point temperature determined according to ASTM D3418-82 by differential thermal analysis (DSC) (also see Zosel, Farbe and Lack 82 (1976), 125-134 and DIN 53765). For sufficient strength of the novel coating, it is advantageous if the glass transition temperature of the polymer is at least −20° C., particularly 0° C. With regard to the resilience of said coating, it is also advantageous if the glass transition temperature T_{g} does not exceed 50° C., in particular 30° C. The glass transition temperature of polymers which are composed of ethylenically unsaturated monomers can be controlled in a known manner by the monomer composition (T. G. Fox, Bull. Am. Phys. Soc. (Ser. II) 1 [1956], 123 and Ullmanns Encyclopedia of Industrial Chemistry 5th Edition, Vol. A21, Weinheim (1989) page 169).

In order to achieve sufficient strength of the coating, it is as a rule necessary for it to contain at least 0.2, preferably at least 0.5, in particular at least 1, part by weight, based on 100 parts by weight of mineral components of the coating, of hydrophobic, film-forming polymer. As a rule, amounts above 20 parts by weight, based on 100 parts by weight of mineral components, will not be required. Preferably, the mineral material which forms the coating contains not more than 15, in particular not more than 10, particularly preferably not more than 5, parts by weight, based on 100 parts by weight of mineral components in the material, of the hydrophobic, film-forming polymer.

According to the invention, the polymer used is hydrophobic. Such polymers are insoluble in water and their polymer films exhibit only slight water absorption, i.e. less than 40 g/100 g, in particular less than 30 g/100 g, of polymer film. Typical hydrophobic polymers are composed of ethylenically unsaturated monomers M, which as a rule comprise at least 80, in particular at least 90, % by weight of ethylenically unsaturated monomers A having a water solubility of <60, in particular <30, g/l (25° C. and 1 bar), it being possible for up to 30, e.g. from 5 to 25, % by weight of the monomers A to be replaced by acrylonitrile and/or methacrylonitrile. In addition, the monomers A also contain from 0.5 to 20% by weight of monomers B differing from the monomers A. Here and below, all quantity data for monomers in % by weight are based on 100% by weight of monomers M.

Monomers A are as a rule monoethylenically unsaturated or conjugated diolefins. Examples of monomers A are:

esters of an α,β-ethylenically unsaturated C₃-C₆-monocarboxylic acid or C₄-C₈-dicarboxylic acid with a C₁-C₁₀-alkanol. These are preferably esters of acrylic acid or methacrylic acid, such as methyl (meth)acrylate, ethyl (meth)acrylate, n-butyl (meth)acrylate, tert-butyl (meth)acrylate, 2-ethylhexyl (meth)acrylate, etc.;

vinylaromatic compounds, such as styrene, 4-chlorostyrene, 2-methylstyrene, etc.;

vinyl esters of aliphatic carboxylic acids of preferably 1 to 10 carbon atoms, such as vinyl acetate, vinyl propiate, vinyl laurate, vinyl stearate, vinyl versatate, etc.;

olefins, such as ethylene or propylene;

conjugated diolefins, such as butadiene or isoprene;

vinyl chloride or vinylidene chloride.

Preferred film-forming polymers are selected from the polymer classes I to IV stated below:

I) copolymers which contain, as monomer A, styrene and at least one C₁-C₁₀-alkyl ester of acrylic acid and, if required, one or more C₁-C₁₀-alkyl esters of methacrylic acid as polymerized units;

II) copolymers which contain, as monomer A, styrene and at least one conjugated diene and, if required, (meth)acrylates of C₁-C₈-alkanols, acrylonitrile and/or methacrylonitrile as polymerized units;

III) copolymers which contain, as monomer A, methyl acrylate, at least one C₁-C₁₀-alkyl ester of acrylic acid and, if required, a C₂-C₁₀-alkyl ester of methacrylic acid as polymerized units;

IV) copolymers which contain, as monomer A, at least one vinyl ester of an aliphatic carboxylic acid of 2 to 10 carbon atoms and at least one C₂-C₆-olefin and, if required, one or more C₁-C₁₀-alkyl esters of acrylic acid and/or of methacrylic acid as polymerized units.

Typical C₁-C₁₀-alkyl esters of acrylic acid in the copolymers of class I to IV are ethyl acrylate, n-butyl acrylate, tert-butyl acrylate, n-hexyl acrylate and 2-ethylhexyl acrylate.

Typical copolymers of class I contain, as monomers A, from 20 to 80, in particular from 30 to 70, % by weight of styrene and from 20 to 80, in particular from 30 to 70, % by weight of at least one C₁-C₁₀-alkyl ester of acrylic acid, such as n-butyl acrylate, ethyl acrylate or 2-ethylhexyl acrylate, based in each case on the total amount of the monomers A.

Typical copolymers of class II contain, as monomers A, in each case based on the total amount of the monomers A, from 30 to 85, preferably from 40 to 80, particularly preferably from 50 to 75, % by weight of styrene and from 15 to 70, preferably from 20 to 60, particularly preferably from 25 to 50, % by weight of butadiene, it being possible for from 5 to 20% by weight of the abovementioned monomers A to be replaced by (meth)acrylates of C₁-C₈-alkanols and/or by acrylonitrile or methacrylonitrile.

Typical copolymers of class III contain, as monomers A, based in each case on the total amount of the monomers A, from 20 to 80, preferably from 30 to 70, % by weight of methyl methacrylate and at least one further monomer, preferably one or two further monomers, selected from acrylates of C₁-C₁₀-alkanols, in particular n-butyl acrylate, 2-ethylhexyl acrylate and ethyl acrylate and, if required, a methacrylate of a C₂-C₁₀-alkanol in a total amount of from 20 to 80, preferably from 30 to 70, % by weight, as polymerized units.

Typical copolymers of class IV contain, as monomers A, based in each case on the total amount of the monomers A, from 30 to 90, preferably from 40 to 80, particularly preferably from 50 to 75, % by weight of a vinyl ester of an aliphatic carboxylic acid, in particular vinyl acetate, and from 10 to 70, preferably from 20 to 60, particularly preferably from 25 to 50, % by weight of a C₂-C₆-olefin, in particular ethylene, and, if required, one or two further monomers selected from (meth)acrylates of C₁-C₁₀-alkanols in an amount of from 1 to 15% by weight, as polymerized units.

Among the abovementioned polymers, the polymers of class I are particularly suitable.

Monomers B which are suitable in principle are all monomers which differ from the abovementioned monomers and are copolymerizable with the monomers A. Such monomers are known to a person skilled in the art and serve as a rule for modifying the properties of the polymer.

Preferred monomers B are selected from monoethylenically unsaturated mono- and dicarboxylic acids of 3 to 8 carbon atoms, in particular acrylic acid, methacrylic acid, itaconic acid, their amides, such as acrylamide and methacrylamide, their N-alkylolamides, such as N-methylolacrylamide and N-methylolmethacrylamide, their hydroxy-C₁-C₄-alkyl esters, such as 2-hydroxyethyl acrylate, 2- and 3-hydroxypropyl acrylate, 4-hydroxybutyl acrylate, 2-hydroxyethyl methacrylate, 2- and 3-hydroxypropyl methacrylate and 4-hydroxybutyl methacrylate, and monoethylenically unsaturated monomers having oligoalkylene oxide chains, preferably having polyethylene oxide chains, with degrees of oligomerization preferably of from 2 to 200, e.g. monovinyl and monoallyl ethers of oligoethylene glycols, and esters of acrylic acid, of maleic acid or of methacrylic acid with oligoethylene glycols.

The proportion of monomers having acid groups is preferably not more than 10, in particular not more than 5, e.g. from 0.1 to 5, % by weight, based on the monomers M. The proportion of hydroxyalkyl esters and monomers having oligoalkylene oxide chains, where present, is preferably from 0.1 to 20, in particular from 1 to 10, % by weight, based on the monomers M. The proportion of the amides and N-alkylolamides, where present, is preferably from 0.1 to 5% by weight.

In addition to the abovementioned monomers B, suitable further monomers B are crosslinking monomers, such as glycidyl ethers and glycidyl esters, e.g. vinyl, allyl and methallyl glycidyl ether, glycidyl acrylate and methacrylate, the diacetonylamides of the abovementioned ethylenically unsaturated carboxylic acids, e.g. diacetone(meth)acrylamide, and the esters of acetylacetic acid with the abovementioned hydroxyalkyl esters of ethylenically unsaturated carboxylic acids, e.g. acetylacetoxyethyl (meth)acrylate. Other suitable monomers B are compounds which have two nonconjugated, ethylenically unsaturated bonds, for example the di- and oligoesters of polyhydric alcohols with α,β-monoethylenically unsaturated C₃-C₁₀-monocarboxylic acids, such as alkylene glycol diacrylates and dimethacrylates, e.g. ethylene glycol diacrylate, 1,3-butylene glycol diacrylate, 1,4-butylene glycol diacrylate and propylene glycol diacrylate, and furthermore divinylbenzene, vinyl methacrylate, vinyl acrylate, allyl methacrylate, allyl acrylate, diallyl maleate, diallyl fumarate, methylenebisacrylamide, cyclopentadienyl acrylate, tricyclodecenyl (meth)acrylate, N,N′-divinylimidazolin-2-one or triallyl cyanurate. Furthermore, vinylsilanes, e.g. vinyltrialkoxysilanes, are also suitable as monomers B.

In order to achieve a uniform distribution of the polymer in the mineral material which forms the coating, it has proven useful if the polymer is used in the form of finely divided particles. Finely divided polymers are understood as meaning those whose weight-average particle diameter d₅₀ does not exceed 10 μm, in particular 2 μm. In particular, the weight-average particle diameter d₅₀ of the polymer particles is from 100 to 2 000 nm. The weight-average particle diameter d₅₀ is understood as meaning the particle diameter at which 50% by weight of the polymer particles have a smaller diameter. The weight-average particle diameter of a polymer can be determined in a known manner with an aqueous dispersion of the particles by quasi-elastic light scattering or by measurement in an ultracentrifuge.

Polymers having such particle diameters are as a rule present as aqueous polymer dispersions or in the form of powders which are obtainable from these dispersions by evaporating the water. For the production of the novel moldings, polymers in the form of aqueous polymer dispersions, in particular those which are obtainable by free radical aqueous emulsion polymerization of the abovementioned ethylenically unsaturated monomers, are therefore preferred. Also preferred are polymer powders prepared therefrom and aqueous dispersions which are obtainable by redispersing the polymer powders in water. Processes for the preparation of aqueous polymer dispersions as well as for the preparation of polymer powders from aqueous polymer dispersions are widely described in the prior art (cf. for example D. Distler, Wässrige Polymerdispersionen, Wiley VCH, Weinheim 1999; H. Warson, Synthetic Resin Emulsions, Ernest Benn Ltd., London 1972, pages 193-242). Both aqueous polymer dispersions and the powders prepared therefrom are moreover commercially available, for example under the ACRONAL®, STYRONAL®, BUTOFAN® and STYROFAN® trade names of BASF Aktiengesellschaft, Ludwigshafen, Germany.

The free radical aqueous emulsion polymerization of the monomers M is effected at, preferably, from 20 to 120° C., in the presence of at least one surfactant and of at least one, preferably water-soluble initiator which initiates free radical polymerization.

Suitable initiators are azo compounds, organic or inorganic peroxides, salts of peroxodisulfuric acid and redox initiator systems. A salt of peroxodisulfuric acid, in particular a sodium, potassium or ammonium salt, or a redox initiator system which contains, as an oxidizing agent, hydrogen peroxide or an organic peroxide, such as tert-butyl hydroperoxide, and, as a reducing agent, a sulfur compound which is selected in particular from sodium bisulfite, sodium hydroxymethanesulfinate and the hydrogen sulfite adduct with acetone is preferably used.

Suitable surfactants are the emulsifiers and protective colloids usually used for emulsion polymerization. Preferred emulsifiers are anionic and nonionic emulsifiers which, in contrast to the protective colloids, generally have a molecular weight of less than 2 000 g/mol and are used in amounts of from up to 0.2 to 10, preferably from 0.5 to 5, % by weight, based on the polymer in the dispersion or on the monomers M to be polymerized.

The anionic emulsifiers include alkali metal and ammonium salts of alkylsulfates (alkyl radical: C₈-C₂₀), of sulfuric monoesters of ethoxylated alkanols (degree of ethoxylation: from 2 to 50, alkyl radical: C₈ to C₂₀) and ethoxylated alkylphenols (degree of ethoxylation: from 3 to 50, alkyl radical: C₄-C₂₀), of alkylsulfonic acids (alkyl radical: C₈ to C₂₀) and of alkylarylsulfonic acids (alkyl radical: C₄-C₂₀). Further suitable anionic emulsifiers are described in Houben-Weyl, Methoden der organischen Chemie, Volume XIV/1, Mackromolekulare Stoffe, Georg-Thieme-Verlag, Stuttgart, 1961, pages 192-208).

The anionic surfactants also include compounds of the formula I

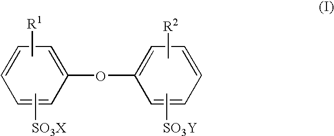

where R¹ and R² are each hydrogen or linear or branched alkyl of 16 to 18, in particular 6, 12 or 16, carbon atoms, R¹ and R² not both being hydrogen simultaneously. X and Y are preferably sodium, potassium or ammonium, sodium being particularly preferred. Frequently, industrial mixtures which contain from 50 to 90% by weight of the monoalkylated product, for example Dowfax® 2A1 (trademark of Dow Chemical Company) are used. The compounds I are generally known, for example from U.S. Pat. No. 4,269,749.

Suitable nonionic emulsifiers are araliphatic or aliphatic nonionic emulsifiers, for example ethoxylated mono-, di- and trialkylphenols (degree of ethoxylation: from 3 to 50, alkyl radical: C₄-C₉), ethoxylates of long-chain alcohols (degree of ethoxylation: from 3 to 50, alkyl radical: C₈-C₃₆) and polyethylene oxide/polypropylene oxide block copolymers. Ethoxylates of long-chain alkanols (alkyl radical: C₁₀-C₂₂, average degree of ethoxylation: from 3 to 50) are preferred and among these those based on oxo alcohols and natural alcohols having a linear or branched C₁₂-C₁₈-alkyl radical and a degree of ethoxylation of from 8 to 50 are particularly preferred.

Anionic emulsifiers, in particular emulsifiers comprising sulfuric monoesters of ethoxylated alkanols, and emulsifiers of the formula I, or combinations of at least one anionic and one nonionic emulsifier, are preferably used.

Suitable protective colloids are, for example, polyvinyl alcohols, starch derivatives and cellulose derivatives, carboxyl-containing polymers, such as homo- and copolymers of acrylic acid and/or of methacrylic acid with comonomers such as styrene, olefins or hydroxyalkyl esters, or vinylpyrrolidone-containing homo- and copolymers. A detailed description of further suitable protective colloids is to be found in Houben-Weyl, Methoden der organischen Chemie, Volume XIV/1, Makromolekulare Stoffe, Georg-Thieme-Verlag, Stuttgart 1961, pages 411-420. Mixtures of emulsifiers and/or protective colloids can also be used.

Of course, the molecular weight of the polymers can be established by adding regulators in a small amount, as a rule up to 2% by weight, based on the polymerizing monomers M. Particularly suitable regulators are organic thio compounds, and furthermore allyl alcohols and aldehydes. In the preparation of the butadiene-containing polymers of class I, frequently regulators are used in an amount of from 0.1 to 2% by weight, preferably organic thio compounds, such as tert-dodecyl mercaptan.

The emulsion polymerization can be carried out either continuously or by the batch procedure, preferably by a semicontinuous method. The monomers to be polymerized can be fed continuously to the polymerization batch, including by the step or gradient procedure. The monomers can be fed to the polymerization both as a monomer mixture and as an aqueous monomer emulsion.

In addition to the seed-free preparation method, the emulsion polymerization can be carried out by the seed latex method or in the presence of seed latex prepared in situ, in order to establish defined polymer particle size. Processes for this purpose are known and are described in the prior art (cf. EP-B 40419 and Encyclopedia of Polymer Science and Technology, Vol. 5, John Wiley & Sons Inc., New York 1966, page 847).

After the actual polymerization reaction, it may be necessary to free the novel, aqueous polymer dispersions substantially from odorous substances, such as residual monomers and other organic volatile components. This can be achieved in a manner known per se physically by removal by distillation (in particular by steam distillation) or by stripping with an inert gas. The content of residual monomers can furthermore be decreased chemically by free radical postpolymerization, in particular under the action of redox initiator systems, as mentioned, for example, in DE-A 44 35 423, DE-A 44 19 518 and DE-A 44 35 422. The postpolymerization is preferably carried out using a redox initiator system comprising at least one organic peroxide and one organic sulfite.

After the end of polymerization, the polymer dispersions used are frequently rendered alkaline, preferably to a pH of from 7 to 10, before they are used according to the invention. Ammonia or organic amines, and preferably hydroxides, such as sodium hydroxide or calcium hydroxide, may be used for the neutralization.

The production of the novel moldings can be carried out in a manner similar to the production of moldings provided with a cement-containing coating, as described, for example, in GB-A 2,030,890 and DE-A 3932573. As a rule, the process for the production of the moldings comprises the following steps:

1. production of an uncoated base element by shaping a cement-containing, plastically deformable mineral material by a known method,

2. application of a plastic, mineral material to the still moist base element, the plastic, mineral material containing at least one clay mineral as the main component and at least one film-forming polymer distributed in the mineral material, conventional assistants and water in an amount which ensures plastic deformability of the material, and

3. setting of the molding.

The production of the base elements is effected in a conventional manner from ready-mixed concrete by a conventional shaping method, for example by an extrusion method or by casting. A suitable extrusion method for concrete roof tiles is described, for example, in German laid-open application DE-OS 3712700 and in DE-A 39 32 573. In this process, a continuous fresh concrete extrudate is applied by means of a fresh concrete application apparatus to fed substrates, compacted by a shaping roll and a calender and then cut at the top and bottom edges by a cutting tool in a cutting station to give base elements of the same length.

In addition to cement, preferably Portland cement, the fresh concrete used contains conventional additives, such as sand, fly ash and colored pigments and, if required, conventional processing assistants, as stated above, if required modified polymers, for example the hydrophobic polymers described above and water for achieving sufficient plasticity of the fresh concrete for processing.

If desired, an aqueous polymer dispersion, preferably a novel aqueous polymer dispersion, is added to the concrete mixes used for the production of the base elements, in an amount such that the plastics/cement weight ratio of the concrete mix is from 1:50 to 1:2, in particular from 1:20 to 1:5, especially about 1:10.

The use of hydrophobic modifying polymers in the concrete mixes used for the production of the base elements leads to moldings having high compressive strength and bending tensile strength.

The mineral coating material polymer-modified according to the invention is then applied to the fresh concrete extrudate thus produced or to the fresh concrete roof tile blanks obtainable after cutting to size. The application is effected by known methods, for example by roll-coating or preferably by extrusion of the plastic mineral material. Thereafter, the base element coated in this manner is as a rule subjected to a second cutting step and then to a setting process.

The coating material is prepared, as a rule, by simply mixing or homogenizing the components: water, mineral material containing clay mineral or clay minerals, and polymer, which are preferably used in the form of an aqueous polymer dispersion or of an aqueous redispersion of a polymer powder. The amount of water required for achieving a material plasticity suitable for processing is as a rule from 10 to 30% by weight, based on the mineral components, and, if a flowable material is to be processed, even higher, e.g. up to 50% by weight.

The clay mineral-containing coating material modified according to the invention with polymer is applied as a rule in an amount such that the mineral coating resulting therefrom has a thickness of from 0.5 to 15 mm. In a preferred embodiment of the invention, the amount applied is chosen so that a layer thickness of from 1 to 5 mm results.

The setting can be effected both at room temperature and by a heat-hardening process at from 20 to 150° C., preferably in the presence of atmospheric humidity. The setting is preferably carried out at from 20 to 95° C., higher temperatures also being possible. Temperatures above 150° C. are in general not used, in order to avoid nonuniform setting. At below 10° C., the setting process is as a rule too slow to be economical.

The clay mineral-containing coating material polymer-modified according to the invention can also be applied to a set base element in the manner described above. Here, higher drying temperatures can then also be used. As a rule, however, temperatures above 250° C., in particular above 200° C., are not used, in order to avoid decomposition of the polymer. However, the polymer-modified mineral coating material is preferably applied to a base element which has not yet set or to a fresh concrete extrudate. Of course, it is also possible to apply a plurality of mineral coatings to the base element.

If the setting is carried out at elevated temperatures, the conventional drying means, such as chamber drying ovens, drum dryers, paddle dryers and infrared dryers, are suitable (cf. Ullmanns Enzyklopädie der Technischen Chemie, 3rd Edition, Vol. 17, page 459 et seq.).

This gives a concrete molding which is provided with at least one clay mineral-containing coating polymer-modified according to the invention and which has the same appearance as a clay tile and comparable weathering resistance and, with respect to its mechanical strength, is comparable with conventional concrete moldings and superior to moldings comprising clay ceramic materials. Surprisingly, in contrast to clay ceramic materials, there is no need for a firing process to achieve the final strength of the mineral coating, making this process particularly economical.

It has proven advantageous if a polymer-bound coating, preferably based on an aqueous polymer dispersion, is applied to the mineral coating of the novel moldings. This polymeric coating can be applied both before and after the setting in step 3. Preferably, the polymer-bound coating materials are applied before the setting in step 3 and the molding thus coated is then subjected to the setting process. The application can be effected in a manner known per se by spraying, troweling, knife-coating, roll-coating or casting.

Suitable coating materials are all polymer-bound coating materials of the prior art which are used for coating conventionally manufactured concrete roof tiles. These are in particular coating materials based on aqueous polymer dispersions of the abovementioned polymer classes I and III.

The polymers in the coating materials preferably have a glass transition temperature of from −20 to +80° C., in particular from 0 to +50° C. Their molecular structure is as a rule comparable with that of the polymers used for modifying the clay mineral-containing material.

Suitable coating materials, as described for coating conventionally manufactured concrete roof tiles, are mentioned in EP-A 469 295, EP-A 492 210, EP 355 028, EP 383 002, EP-A 941 977, DE-A 197 49 642, DE-A 198 10 050, DE-A 40 03 909 and DE-A 43 41 260. The coating materials described in the abovementioned patent applications as well as the coating processes described there for conventionally produced concrete roof tiles can all be applied to the novel moldings. To this extent, the disclosure of these publications is hereby incorporated by reference in its entirety.

The polymer-bound coating materials are as a rule applied in pigment-containing form, i.e. in the form of a color. Of course, they may also be applied in the-form of a pigment-free formulation, i.e. in the form of a clear coat, to the surface to be coated. Pigment-containing coatings contain, as a rule, iron oxide pigments for coloring and conventional fillers, such as calcium carbonate, barium sulfate, talc, etc.

The polymer-bound coating materials can be applied in one layer or in a plurality of layers to that surface of the novel molding which is to be coated.

In a very particularly preferred embodiment of the novel process, a pigment-free coating material based on an aqueous polymer dispersion, preferably a pure acrylate dispersion or a styrene/acrylate dispersion, is applied to the novel moldings, preferably in the moist state, in a first step. In a second step, a further, polymer-bound coating material, preferably based on a styrene/acrylate dispersion or a pure acrylate dispersion, is applied to the molding provided in this manner with a polymer-bound coating. The second coating material is as a rule formulated as a color, i.e. it contains color pigments and, if required, fillers. In such colors, the content of pigment plus filler is as a rule from 5 to 100% by weight, based on the polymer contained in the color. Further pigment-free or pigment-containing coating materials based on aqueous polymer dispersions or other polymers can be applied to this color coating. If the second polymer coating comprises a plurality of different polymer layers, the second coating initially applied contains, as a rule, more pigment than the subsequently applied further layers.

The amounts of the individual polymer coating materials applied are as a rule chosen so that the first coating has a weight per unit area of from 50 to 500 g/m² and the second coating and further coatings have a total weight per unit area of from 50 to 500 g/m² (calculated as dry substance). The first coating serves as a primer or as an adhesion promoter for the second coating and the further coatings. Of course, it is also possible to apply only one coating, which may be pigment-free or pigment-containing, to the molding, for example in an amount of from 50 to 500 g/m² (calculated as dry substance).

The use of a pigment-containing coating (color) has the advantage that the novel molding need not be colored right through with pigments but has the desired coloring only on the visible surfaces. On the one hand, this reduces costs since the amount of pigment required for achieving the colored appearance can be reduced by more than a half and, on the other hand, it increases the range of materials which may be used, some of which have to be brought to the desired color-imparting form by the addition of pigment. Surprisingly, it has not been possible to date to realize a colored coat in the case of conventional clay ceramic moldings, since the color adhered only poorly.

The examples which follow illustrate the invention but are not restrictive.

I. Materials Used

The mineral material used was a mixture of an illite-containing clay having a particle size of less than 2 μm and sand.

Polymer P1

Copolymer of 63 parts by weight of styrene and 32 parts by weight of butadiene, 2.5 parts by weight of acrylonitrile and 2.5 parts by weight of N-methylacrylamide, having a glass transition temperature of 17° C.

Polymer P1 was used in the form of a 50% strength by weight aqueous polymer dispersion, which was stabilized with 1% by weight of ethoxylated C₁₃ fatty alcohol and 1.5% by weight of the sodium salt of a sulfuric monoester of ethoxylated C₁₂ alcohol. The polymer dispersion had a minimum film formation temperature of 16° C.

Polymer P2

Copolymer of 54 parts by weight of styrene and 46 parts by weight of 2-ethylhexyl acrylate and 2.6 parts by weight of acrylic acid, 1 part by weight of acrylamide and 0.5 part by weight of methacrylamide, having a glass transition temperature of 12° C., in the form of a 50% strength by weight aqueous polymer dispersion having a minimum film formation temperature of 20° C. For stabilization, the dispersion contained 0.4% by weight of nonylphenol ethoxylate (degree of ethoxylation 25) and 1.2% by weight of the sodium salt of the sulfuric monoester of nonylphenol ethoxylate (degree of ethoxylation 25).

Polymer P3

Copolymer of 62 parts by weight of styrene and 34 parts by weight of n-butyl acrylate and 1.5 parts by weight of acrylic acid and 2.5 parts by weight of N-methylolmethacrylamide, having a glass transition temperature of 34° C., in the form of a 50% strength by weight aqueous polymer dispersion having a minimum film formation temperature of 30° C.

II. Production of a Molding in the Form of an Arched Tile (Examples 1, 2 and 3 and Comparative Examples C1 and C2)

For the production of a mineral coating material, 100 parts by weight of the clay mineral powder were mixed with 20 ml of water and a defined amount of the polymer dispersion P1, P2 or P3 to give a plastically deformable material. The polymer content was 3 parts by weight, based on 100 parts by weight of mineral components. For comparative experiment C1, a coating material which contained no polymer was used.

An arched concrete extrudate having a thickness of about 2 cm and a width of 12 cm was produced by extrusion from a plastic concrete mix which contained sand (particle size up to 0.3 mm), cement and water in a weight ratio of 4:1:0.4. The vertex of the arch was 4 cm above the base area. Said extrudate was divided into about 20 cm long concrete tile blanks by means of a cutting tool. One of the mineral coatings described above was extruded in a thickness of about 3 mm onto these concrete tile blanks. Thereafter, drying was carried out for 2 hours at 40° C. and 75% relative humidity and then for 4 hours at 60° C. and 95% relative humidity.

For a further comparative experiment C2, a concrete tile which had the abovementioned dimensions and no mineral coating was produced in the manner described above.

III Testing of Performance Characteristics

1. Determination of the Efflorescence

After drying, the tile was placed for 7 days face down on a water bath at 60° C. The degree of efflorescence was assessed visually. The following rating scale was taken as a basis for this purpose. The results are summarized in Table 4.

0=no efflorescence

1=virtually no efflorescence

2=slight efflorescence

3=moderate efflorescence

4=pronounced efflorescence

5=very pronounced efflorescence

2. Determination of the Gloss

A tile treated according to 1. with steam was assessed with respect to its gloss in the areas which were in direct contact with the steam. The decrease in gloss is a measure of the erosion of the surface.

0=very high gloss

1=high gloss

2=moderate gloss

3=slight gloss

4=matt

5=dull

3. Adhesion/Surface Stability

A tile treated according to 1. with steam was assessed with respect to the adhesion of the mineral coating on the base element and the adhesion of dispersion colors on the mineral coating in the areas which were in direct contact with the steam. The adhesion of the color or the surface stability of the coating was determined by means of a 10 cm long self-adhesive tape (TESA tape), which was applied to the tile under slight pressure using a rubber roller. After a few minutes, the self-adhesive tape was removed by rapidly pulling it off. The components adhering to the self-adhesive tape and their amount were assessed visually according to the scale shown below.

0=no detectable components

1=slightly detectable

2=readily detectable

3=striking

4=highly striking

5=very highly striking

TABLE 1

| Example | Coating | Polymer | Efflorescence | Gloss | Adhesion |
|---|---|---|---|---|---|
| 1 | mineral | P1 | 1 | 2 | 1 |
| 2 | mineral | P2 | 1 | 2 | 1 |
| 3 | mineral | P3 | 1 | 2 | 1 |
| C1 | mineral without | — | 2 | 3 | 5 |
| | polymer | | | | |
| C2 | none | — | 5 | 5 | n.d. |

IV Molding having a Polymer-Bound Coating:

0.5 g of a commercial antifoam (TEGO Foamex 825 from Th. Goldschmidt AG) and 5 g of an industrial mixture of the di-n-butyl ester of succinic, glutaric and adipic acid were added to 100 g each of a commercial dispersion based on styrene/n-butyl acrylate (dispersion E1, MFT of 30° C.), a dispersion based on methyl methacrylate/2-ethylhexyl acrylate (dispersion E2, MFT of 28° C.) and a dispersion E3 (composed of 42 parts by weight of n-butyl acrylate, 58 parts by weight of methyl methacrylate, 1.5 parts by weight of acrylic acid, 0.5 parts by weight of acrylamide and 1 part by weight of allyl methacrylate, having a glass transition temperature of 38° C.). The dispersions prepared in this manner served as a clear coat (pigment volume concentration PVC=0).

A dispersion color F1 having a pigment volume concentration PVC of 40 was formulated from the prepared dispersion E1. For this purpose, 235.3 g of a commercial filler (calcium carbonate/calcium silicate) and 58.8 g of iron oxide red pigment from BAYER AG were suspended in 117.6 g of water. 588.3 g of the prepared dispersions E1 and E2 were added while stirring. The colors thus obtained were allowed to ripen for 48 hours at room temperature before their performance characteristics were tested.

The colors and the clear coats were applied by means of a spray gun to moldings which were produced according to examples 1 to 3 and comparative examples C1 and C2, application being effected on the surface provided with the mineral coating, prior to setting or drying of the moldings. The amount applied was about 20 g/tile in the case of the colors with PVC 40 and about 10 g/tile in the case of the colors with PVC 0. Thereafter, drying was carried out for 2 hours at 40° C. and 75% relative humidity and then for 4 hours at 40° C. and 95% relative humidity.

The testing of the performance characteristics with respect to efflorescence, loss of gloss and color adhesion was carried out as described under III. The results are summarized in Table 2.

TABLE 2

| Example | Mineral coating | Color | Efflorescence | Gloss | Adhesion |
|---|---|---|---|---|---|
| C3 | none | F1 | 1 | 4 | 2 |
| C4 | mineral without | F1 | 1 | 4 | 5 |
| | polymer | | | | |
| 4 | mineral/P1 | F1 | 1 | 4 | 2 |
| 5 | mineral/P2 | F1 | 1 | 4 | 2 |
| 6 | mineral/P3 | F1 | 1 | 4 | 2 |
| C5 | none | E2 | 1 | 3 | 2 |
| C6 | mineral without | E2 | 1 | 2 | 5 |
| | polymer | | | | |
| 7 | mineral/P1 | E2 | 1 | 2 | 2 |
| 8 | mineral/P2 | E2 | 1 | 2 | 2 |
| 9 | mineral/P3 | E2 | 1 | 2 | 2 |
| C7 | none | E3 | 4 | 1 | 3 |
| C8 | mineral without | E3 | 1 | 1 | 5 |
| | polymer | | | | |
| 10 | mineral/P1 | E3 | 1 | 1 | 2 |
| 11 | mineral/P2 | E3 | 1 | 1 | 2 |
| 12 | mineral/P3 | E3 | 1 | 1 | 2 |

We claim:

1. A molding comprising a base element consisting of a cement-bound mineral material, which may be modified with polymers, and a mineral coating present on at least one of the main surfaces of the base element and comprising a polymer-modified mineral material which contains at least one clay mineral as the main component and from 0.2 to 20 parts by weight, based on 100 parts by weight of mineral components of the coating, of at least one film-forming, hydrophobic polymer distributed in the mineral material.

2. A molding as claimed in claim 1 in the form of a roof tile, the mineral coating being provided on the main surface intended as the weather side.

3. A molding as claimed in claim 1 or 2, wherein the coating has a thickness of from 0.5 to 15 mm.

4. A molding as claimed in any of the preceding claims, wherein the polymer has a glass transition temperature of from −20 to +80° C.

5. A molding as claimed in any of the preceding claims, wherein the polymer is composed of ethylenically unsaturated monomers M, comprising
from 80 to 99.5% by weight of ethylenically unsaturated monomers A having a water solubility of <60 g/l (25° C. and 1 bar)
from 0.5 to 20% by weight of monomers B differing from the monomers A,
all data in % by weight being based on 100% by weight of monomers M and it being possible for up to 30% by weight of the monomers A to be replaced by acrylonitrile and/or methacrylonitrile.

6. A molding as claimed in claim 5, wherein the polymers are selected from
I) copolymers which contain, as monomer A, styrene and at least one C₁-C₁₀-alkyl ester of acrylic acid and, if required, one or more C₁-C₁₀-alkyl esters of methacrylic acid as polymerized units;
II) copolymers which contain, as monomer A, styrene and at least one conjugated diene and, if required, (meth)acrylates of C₁-C₈-alkanols, acrylonitrile and/or methacrylonitrile as polymerized units;
III)copolymers which contain, as monomer A, methyl acrylate, at least one C₁-C₁₀-alkyl ester of acrylic acid and, if required, a C₂-C₁₀-alkyl ester of methacrylic acid as polymerized units;
IV) copolymers which contain, as monomer A, at least one vinyl ester of an aliphatic carboxylic acid of 2 to 10 carbon atoms and at least one C₂-C₆-olefin and, if required, one or more C₁-C₁₀-alkyl esters of acrylic acid and/or of methacrylic acid as polymerized units.

7. A molding as claimed in claim 5 or 6, wherein the monomers B are selected from monoethylenically unsaturated mono- and dicarboxylic acids of 3 to 8 carbon atoms, their amides, their N-alkylolamides, their hydroxy-C₁-C₄-alkyl esters and monoethylenically unsaturated monomers having oligoalkylene oxide chains.

8. A molding as claimed in any of the preceding claims, wherein the polymer is obtainable by free radical aqueous emulsion polymerization.

9. A molding as claimed in any of the preceding claims, which additionally has a polymer-bound pigment-containing coating on the mineral coating.

10. A process for the production of a molding provided with a mineral coating, as claimed in any of claims 1 to 9, comprising the following steps:
1. production of an uncoated base element by shaping a cement-containing, plastically deformable mineral material by a known method,
2. application of a plastic, mineral material to the still moist base element, the plastic, mineral material containing at least one clay mineral as the main component and from 0.2 to 20 parts by weight, based on 100 parts by weight of mineral components of the coating, of at least one film-forming, hydrophobic polymer distributed in the mineral material, conventional assistants and water in an amount which ensures plastic deformability of the material, and
3. setting of the molding.

11. A process as claimed in claim 10, wherein the setting is carried out at from 20 to 150° C.

12. A process as claimed in either of claims 10 and 11, wherein a pigment-containing coating is additionally applied to the mineral coating, before or after setting of the molding and before or after drying of the molding.
